(19) United States
(12) Patent Application Publication
(10) Pub. No.: US 2008/0256489 A1
(43) Pub. Date: Oct. 16, 2008

(54) Range Sliders with Linked Auto-Updating Spans

(75) Inventors: Steven D. Maurer, Aloha, OR (US); Benjamin T. Humble, Beaverton, OR (US)

Correspondence Address: MATTHEW D. RABDAU;TEKTRONIX, INC., 14150 S.W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 12/104,371

(22) Filed: Apr. 16, 2008

Related U.S. Application Data
(60) Provisional application No. 60/912,159, filed on Apr. 16, 2007.

(51) Int. Cl. G06F 3/048

(52) U.S. Cl. 715/833

(57) ABSTRACT

A graphical user interface (GUI) is provided for use in a system, such as a video test and measurement instrument. The GUI provides a mechanism for a user to select one, or more, ranges of values. Embodiments of the GUI provide an ability to correlate ranges between a first sequence and second sequence, such that two ranges of values are related in some fashion.

### CROSS-REFERENCE TO RELATED APPLICATIONS

This application claims the benefit of U.S. Provisional Application No. 60/912,159 filed on Apr. 16, 2007, entitled Range Sliders with Linked Auto-Updating Spans, which application is hereby incorporated herein by reference.

### BACKGROUND

Embodiments of the present invention relate to user interfaces for setting ranges using sliders, and more particularly to setting ranges in test and measurement equipment, such as video test and measurement equipment.

In products for which selecting a range of values is desired, it is useful from a user interface perspective to present controls that can be manipulated, for example using a mouse or other pointing device, and are aesthetically pleasing, and easily recognized.

Several graphical user interface (GUI) design mechanisms have been developed for specifying a multiple value region of interest (ROI). Several examples of range sliders are shown in FIGS. 1 through 3. The slider shown in FIG. 1 provides the ability to define a range of interest, along with linked text boxes to show values, possibly with greater precision. However, because the handles are inside the bar it is not possible to specify a zero range, and it is further not possible to reverse the ranges. The examples shown in FIGS. 2 and 3, do provide the ability to set a zero span range. However, they do not allow the start and stop values to be reversed. When generating GUIs it is generally desirable to provide a uniform look and feel throughout the application. It is further desirable to use those elements that are available as standard objects within the operating systems or design environment. While the example solutions provided have the ability to select a range in some way, they do not have the look of a standard OS. This may require the generation of custom bit maps, and additional coding to properly provide for these range defining objects. It would be desirable for example in a Windows XP environment to match the look and feel of single point sliders, as shown in FIG. 4. Unfortunately, most commonly recognized single pointer controls select the value corresponding to the midpoint of the slider icon, or its bit-map.

In addition to the general desirability of an aesthetic user interface, test and measurement applications have additional considerations related to functionality. For example, products that compare ranges from two different sources should provide a way to set the range for each source. In the case of video or audio comparison, matching a reference sequence to a test sequence is problematic. After a reference sequence has been processed through a series of devices under test, the resulting captured test sequences may be distorted to such a degree that automated systems, such as that implemented in the TEKTRONIX® PQA200, may have difficulty determining the original start. Because of frame skipping, the need to control variables when refining compression algorithms and test speed considerations, users demand the ability to easily select test and reference sequence ranges.

### SUMMARY

Accordingly, embodiments of the present invention a GUI that has the look and feel of the operating system, or operating environment that the rest of the application uses. Further embodiments provide an ability to correlate ranges between a first sequence and second sequence, for example in the case of video measurements a reference sequence and a test sequence may be used. Additional embodiments allow the user to select all legal regions of interest ranges, while preventing requests for impossible measurements.

A graphical user interface (GUI) is provided for use in a system, such as a video test and measurement instrument. The GUI provides a mechanism for a user to select one, or more, ranges of values. In a first embodiment, a single span control is provided having a rule line corresponding to a range of values for determining a span. A first slider is provided for selecting a starting point within the range of value. This slider is presented as an arrowhead offset from the rule line and pointing for example down at the rule line. A second slider is provided for selecting an ending point within the range of values. This second slider is presented as an arrowhead offset from the rule line and pointing for example up towards to the rule line. This enables the selection of the span to include the ability to select a zero span, wherein the start and ending points are the same. In the case of a video measurement, this might correspond to selecting a single frame for analysis. In some applications, it would be possible to provide an ending point that occurs prior to a starting point which would in effect span to be negative, corresponding to running a video sequence backwards, for example.

In a further embodiment of the span control, two or more span controls are related such that changes in one span control causes changes in other span controls. For example in a video measurement, it may be desirable to maintain equivalent span lengths for a reference video sequence and a test video sequence. In this embodiment, a first span control may relate to a reference sequence and a second span control may relate to a test sequence. The two span controls are related such that the two span lengths adjust to maintain approximate equality of the spans as the sliders of each control are moved.

### BRIEF DESCRIPTION OF THE FIGURES

FIG. 1 (Prior Art) shows a prior art range slider.

FIG. 2 (Prior Art) shows a prior art range slider.

FIG. 3 (Prior Art) shows a prior art range slider.

FIG. 4 (Prior Art) shows a prior art range slider.

FIG. 5 shows a range slider for defining a single range of values according to an embodiment of the present invention.

FIG. 6 shows a pair of related range sliders according to an embodiment of the present invention.

FIG. 7 shows a pair of related range sliders according to an embodiment of the present invention.

FIG. 8 shows a pair of related range sliders according to an embodiment of the present invention.

FIG. 9 shows a pair of related range sliders according to an embodiment of the present invention.

FIG. 10 shows a pair of related range sliders according to an embodiment of the present invention.

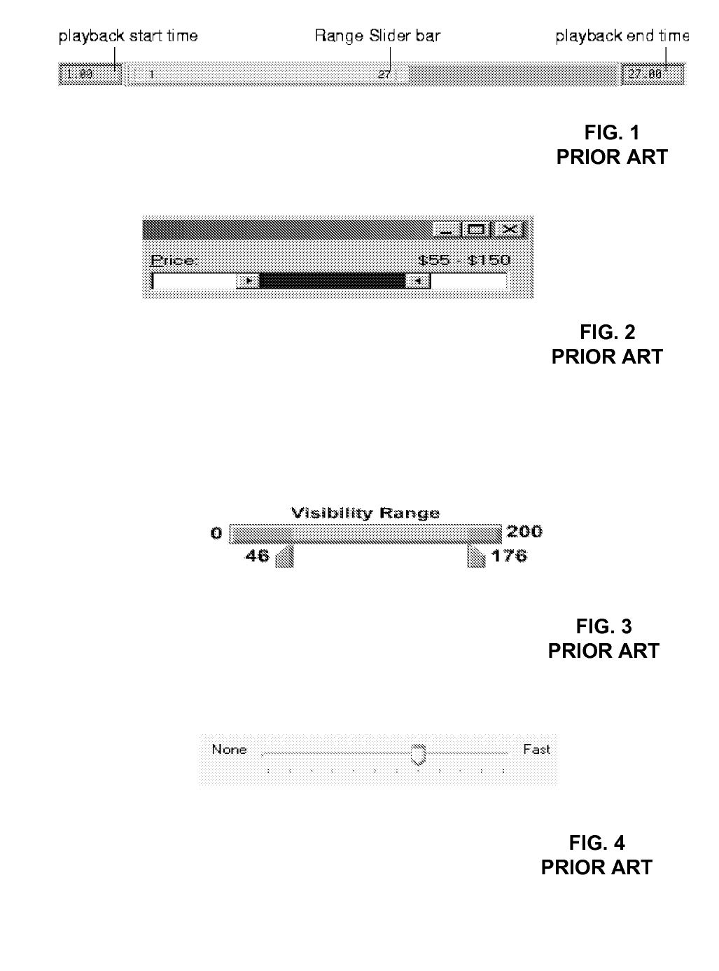

### DETAILED DESCRIPTION

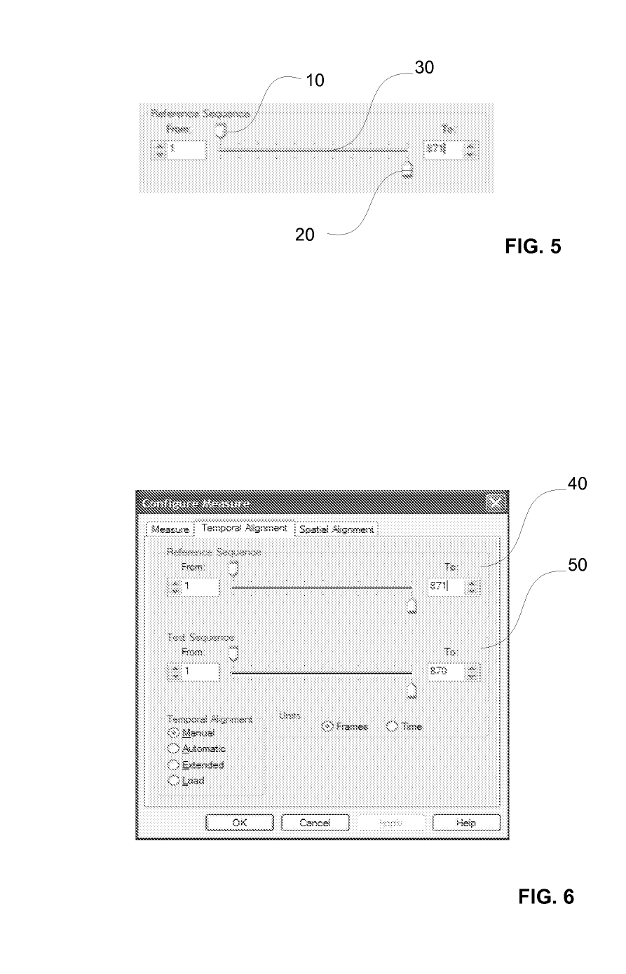

FIG. 5 shows an illustration of a simple range slider according to an embodiment of the present invention. The range slider uses a first slider 10 that corresponds to a standard single value range slider provided by the operating system. A second slider 20 is provided that corresponds to an inverted version of the first slider 10. The second slider 20 is offset from the first slider 10. As shown, the sliders are vertically offset. In other embodiments, the whole range could be rotated 90 degrees, such that the sliders were horizontally offset. In this example, the first slider 10 controls the start of a sequence, while the second slider 20 controls the end of the sequence. As shown in this example, the span between the two end-points of the dual sliders equals the distance between the midpoints of each slider, respectively. Since the first slider 10 and the second slider 20 are on opposite sides of a rule line 30, it is possible to set a zero span range. Also since they can pass over, or under each other, it would be possible in some embodiments to provide start and stop points that would correspond to negative ranges, such that objects in the range would be run backwards for example. Since this would not be desirable in some applications, in other embodiments rules would be established to prevent the setting of negative ranges, such that the end point could never be prior to the start point.

A further embodiment of the present invention is shown in FIG. 6. It is composed of two related sets of range sliders. The first set of range sliders 40 relates to the reference sequence, while the second set of range sliders relates to the test sequence 50. The rules and relationships between the pairs of sliders 40 and 50 may be set according to the application as desired.

In specific embodiments of the present invention, the pair of ranges may be used for example in connection with video testing. In video, or audio testing, the range would often correspond to time, either actual units of time such as seconds, minutes, or fractions thereof, or in terms of frames of video, which based upon the frame rate would correspond to time as well. In the example shown in FIG. 6, the reference sequence spans 870 frames, from 1 to 871, while the test sequence spans 869 frames, from 1 to 870. This illustrates a case in which the reference sequence is at 30 frames per second, while the test sequence is at 29.97 frames per second. In this example, although the range is provided in terms of frames, the actual time between the two is being maintained to a desirable level of accuracy. As those skilled in the art understand that all equalities are in terms of reasonable tolerances, or at least sufficiently equal for the desired level of accuracy, the term approximately equal refers to equal within acceptable tolerances in order to make measurements to a desired level of accuracy. In some cases, this will be equal numbers of frames, or as described in connection with FIG. 6 equal in time given the constraints of different frame rates. Accordingly, the span between the two end-points of the top dual sliders equals the distance between the bottom two sliders, as expressed in time.

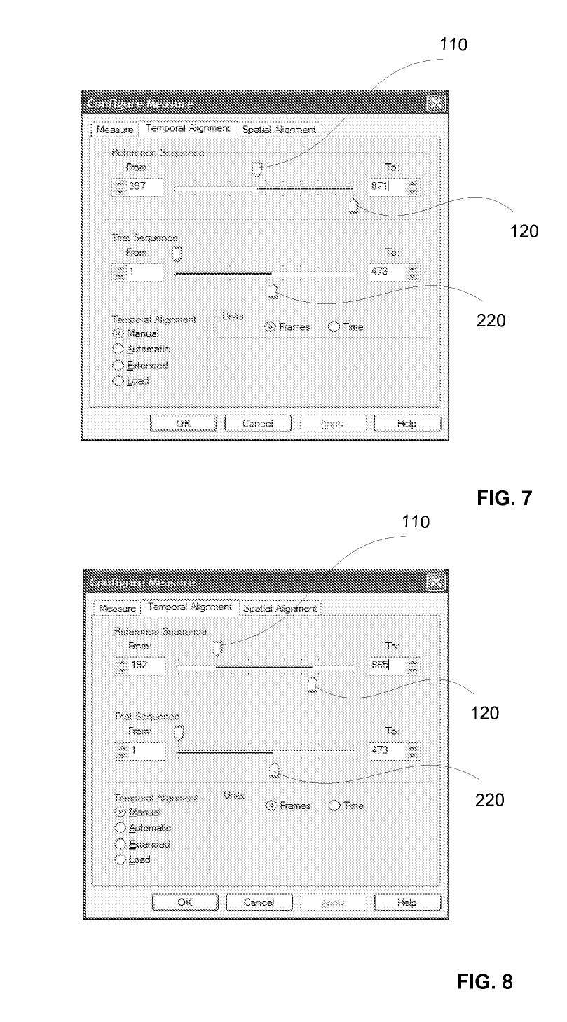

In an embodiment of the present invention, it is desirable to preserve the equality of the length of the spans. This temporal equality in length of spans is preserved by automatically updating the position of other sliders. In the continuing example, the selected top/left slider 110 has been moved by the user to the right. In this example, manipulating the top/left slider allows the user to adjust the start point of one sequence without changing the start point of the other sequence. Because the paired bottom/right Reference slider 120 cannot move to the right, since it is at the Reference sequence endpoint, the bottom/right Test sequence slider 220 moves to the left reducing the paired Test Sequence span to maintain the temporal equality, as shown in FIG. 7.

As shown in FIG. 8, when the bottom/right handle of the Reference sequence 120 is not constrained by the endpoint of the sequence, a user update of the top/left value will preserve the span by moving the bottom/right handle of the Reference sequence without changing the Test Sequence. In the running example above, the user has moved the selected top/left Reference slider 110 to the left, automatically updating the bottom/right Reference slider 120. The Test Sequence controls are left untouched by this manipulation, yet the temporal equality is maintained.

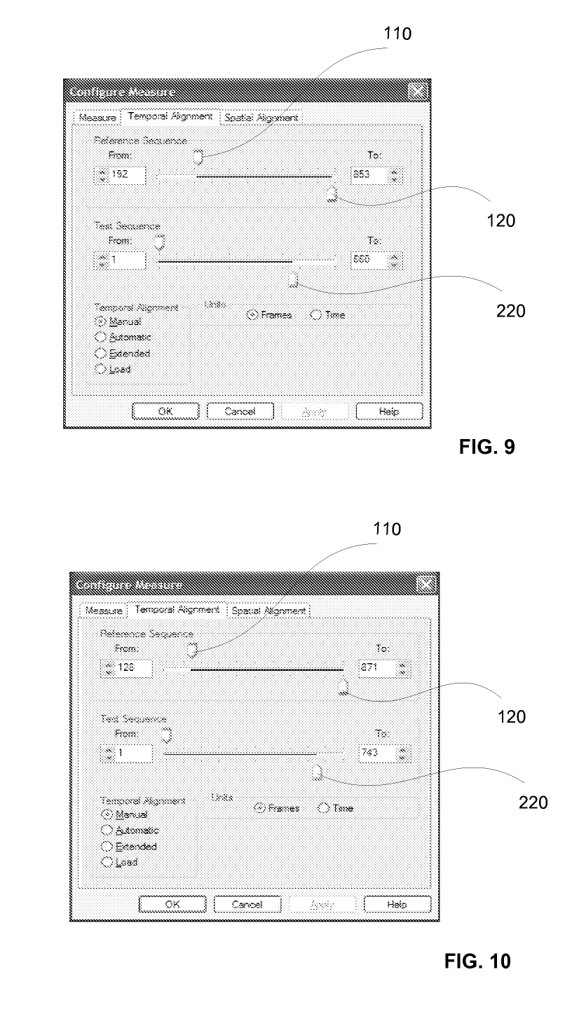

In the current example, user manipulation of the bottom/right (or endpoint) sliders behaves differently. The bottom/right sliders are intended to alter the span. Accordingly, user manipulation of the bottom/right slider does not automatically adjust the position of the top/left slider of the same sequence. Rather, when the user moves the bottom/right slider 220 for the Test sequence, for example to the right, the bottom/right slider 120 of the Reference sequence also moves to the right to preserve the span, as shown in FIG. 9.

As shown in FIG. 10, when the corresponding top/left slider may move as required to maintain the span. For example, when the user moves the bottom/right slider 220 of the Test sequence until the bottom/right slider 120 of the Reference sequence reaches its limit, the top/left slider of the Reference sequence moves to the left instead to preserve the span equality.

In the embodiments illustrated by FIGS. 6 through 10, the lower/right “to” control is constrained by not being able to move to the left of the upper/left “from” control. Note that sliders may also be referred to as handles, or controls.

Although rules for the relationships between the sliders has been described in detail in connection with video test sequences, embodiments and aspects of the present invention have broader applicability to other applications. In these other applications, the relationships between the various sliders in two, or more, interrelated sliders, can be set by rules appropriate to that application. Also, in the case of video or audio test, the relationships between the sliders can be set to behave differently, while providing the desired preservation of the span.

What is claimed is:

1. A system having a display adapted to present a graphical user interface to an end-user for selecting ranges of values comprising:
a first span control corresponding to a first range of values provided along a first rule line, wherein the first span control comprises a first starting point slider and a first ending point slider; and
a second span control corresponding to a second range of values provided along a second rule line, wherein the second span control comprises a second starting point slider and second ending point slider, wherein the second span control is related to the first span control such that changes made using the first span control affect the second span control.

2. The system of claim 1, wherein the distance between the first starting point slider and the first ending point slider define a first span length; the distance between the second starting point slider and the second ending point slider define a second span length; and the first span control and the second span control are related such that the first span length and the second span length remain approximately equal as sliders are moved.

3. The system of claim 1, wherein adjusting the first starting point slider adjusts the starting point for the first span control.

4. The system of claim 1, wherein adjusting the second starting point slider adjusts the starting point for the second span control.

5. The system of claim 1, wherein adjusting the first starting point slider towards the first endpoint slider when the first ending point slider is constrained causes the second ending point slider to move to toward the second starting point slider to maintain equality between the first span length and the second span length.

6. The system of claim 1, wherein adjusting the first ending point slider adjusts the first span length.

7. The system of claim 1, wherein adjusting the second ending point slider adjusts the second span length.

8. The system of claim 1, wherein adjusting the first ending point slider towards the first starting point slider when the first starting point slider is constrained causes the second starting point slider to move towards the second ending point slider to maintain equality between the first span length and the second span length.

9. The system of 1, wherein the first starting point slider is displayed as an arrowhead offset from the first rule line on a first side of the first rule line, and the first ending point slider is displayed as an arrowhead offset from the first rule line on a second side of the first rule line opposite the first side of the first rule line.

10. A system having a display adapted to present a graphical user interface to an end-user for selecting a range of values comprising:
a rule line corresponding to a range of values;
a first slider for selecting a starting point within the range of values, wherein the first slider is displayed as an arrowhead offset from the rule line on a first side of the span; and
a second slider for selecting an end point within the range of values, wherein the second slider is displayed as an arrowhead offset from the rule line on a second side of the rule line opposite the first side of the rule line.

11. A method of defining two related ranges of values comprising:
providing a graphical user interface having a first set of range controls for defining a first starting point and a first ending point along a first rule line, and a second set of range controls for defining a second starting point and a second ending point along a second rule line;
automatically adjusting the second set of range controls in response to adjustments made in the first set of range controls.

12. The method of claim 11, wherein the difference between the first starting point and the first ending point define a first span length, the difference between the second starting point and the second ending point define a second span length, and the first span length and the second span length are maintained to be approximately equal.

13. The method of claim 11, wherein adjusting the first starting point causes the first ending point to adjust to maintain the first span length without changing the second set of range controls.

14. The method of claim 11, wherein adjusting the first starting point when the first ending point is constrained automatically adjusts the second ending point to maintain approximate equality with an adjusted first span length.

15. The method of claim 11, wherein adjusting the first ending point causes the second ending point to adjust automatically to maintain approximate equality with an adjusted first span length.

16. The method of claim 11, wherein adjusting the first ending point when the second ending point is constrained automatically adjusts the second starting point to maintain approximate equality with an adjusted first span length.
